(19) United States
(12) Patent Application Publication
(10) Pub. No.: US 2024/0027793 A1
(43) Pub. Date: Jan. 25, 2024

(54) A LENS SYSTEM FOR CONTROLLING ANISOMETROPIA AND A METHOD THEREOF

(71) Applicant: SHAMIR OPTICAL INDUSTRY LTD., Kibbutz Shamir (IL)

(72) Inventors: Dana Margit GOTTHILF-NEZRI, Ganey Tikva (IL); Liron GLESER, Rosh Pina (IL)

(21) Appl. No.: 18/257,350

(22) PCT Filed: Dec. 6, 2021
(86) PCT No.: PCT/IL2021/051448

§ 371 Date: Jun. 14, 2023

(30) Foreign Application Priority Data
Dec. 14, 2020 (IL) 279439

(51) Int. Cl. G02C 7/04; G02C 7/02

(52) U.S. Cl. CPC G02C 7/044; G02C 7/027; G02C 2202/24

(57) ABSTRACT

The present invention relates to a myopia control lens being configured for controlling anisometropia in patients with at least one myopic or pre-myopic eye. More specifically, the invention relates to at least one ophthalmic lens for spectacles or contact lens configured for controlling and/or treating anisometropia (prevention and minimization) The ophthalmic lens of the present invention may be used in any anisometropic cases where at least one of the eyes is myopic or pre-myopic, whether the refraction and prescription is spherical and/or astigmatic.

### TECHNOLOGICAL FIELD

This relates to a lens system for controlling anisometropia and a method thereof and more particularly for configuring a lens system to affect the progression of myopia and controlling anisometropia in patients with at least one myopic or pre-myopic eye.

### BACKGROUND ART

References considered to be relevant as background to the presently disclosed subject matter are listed below:
1. Chen J, He J C, Chen Y, Xu J, Wu H, Wang F, Lu F, Jiang J. “Interocular Difference of Peripheral Refraction in Anisomyopic Eyes of Schoolchildren”. PLoS One. 6; 11(2), 2016.
2. Deng L, Gwiazda J E. “Anisometropia in children from infancy to 15 years”. Invest Ophthalmol Vis Sci. 20; 53(7):3782-7, 2012.
3. Cheng C Y, Yen M Y, Lin H Y, Hsia W W, Hsu W M. “Association of ocular dominance and anisometropic myopia”. Invest Ophthalmol Vis Sci. 2004.
4. Weale R A. “On the age-related prevalence of anisometropia”. Ophthalmic Res. 34(6):389-92, 2002.
5. Fu A C, Qin J, Rong J B, Ji N, Wang W Q, Zhao B X, Lyu Y. “Effects of orthokeratology lens on axial length elongation in unilateral myopia and bilateral myopia with anisometropia children”. Cont Lens Anterior Eye. 43(1):73-77, 2020.
6. Zhong Y, Ke L, Qiong W, Liu F. “Orthokeratology lens for management of myopia in anisometropic children: A contralateral study”. Cont Lens Anterior Eye. 43(1):40-43, 2020.
7. Chen Z, Zhou J, Qu X, Zhou X, Xue F; SOS Group. “Effects of orthokeratology on axial length growth in myopic anisometropes”. Cont Lens Anterior Eye. 41(3):263-266, 2018.
8. Tsai W S, Wang J H, Lee Y C, Chiu C J. “Assessing the change of anisometropia in unilateral myopic children receiving monocular orthokeratology treatment”. J Formos Med Assoc. 118(7):1122-1128, 2019.
9. Mutti D O, Hayes J R, Mitchell G L, Jones L A, Moeschberger M L, Cotter S A, Kleinstein R N, Manny R E, Twelker J D, Zadnik K, CLEERE Study Group. “Refractive Error, Axial Length, and Relative Peripheral Refractive Error Before and After the Onset of Myopia”. Invest Ophthalmol Vis Sci 48(6):2510-2509, 2007.
10. Bullimore M A, Richdale K. “Myopia Control 2020: Where Are We and Where Are We Heading?”. Ophthalmic Physiol Opt; 40(3):254-270. 2020.
11. Zadnik K, Sinnott L T, Cotter S A, Jones-Jordan L A, Kleinstein R N, Manny R E, Twelker J D, Mutti D O, CLEERE Study Group. “Prediction of Juvenile-Onset Myopia”. JAMA Ophthalmol. 133(6): 683-689, 2015.

Acknowledgement of the above references herein is not to be inferred as meaning that these are in any way relevant to the patentability of the presently disclosed subject matter.

### BACKGROUND

Anisometropia is a condition where the refractive error differs between the two eyes. The difference in the axial lengths of the eyes is considered to be the principal cause of anisometropia (the more myopic eyes being more elongated). Any refractive error difference between the two eyes is to the detriment of the patient, whereas even a small difference (e.g. 0.25D or 0.5D) can be considered a less severe case of anisometropia. Anisometropia is a phenomenon that has negative impacts on visual skills and development. The negative impacts may be as follows: improper binocular development and impaired stereopsis (the higher the anisometropia, the poorer the binocular function); amblyopia and strabismus (anisometropia is a major cause for the development of amblyopia and increasing degree of anisometropia is associated with higher risk of developing strabismus); aniseikonia (i.e. difference in the perceived size or shape of retinal images between eyes); possible spectacle intolerance for Single Vision (SV) and Progressive Addition Lenses (PAL) and accommodative instability. Therefore, it is recommended to start treatment as soon as possible and in every refractive difference between the two eyes. The prevalence of anisometropia increases from preschool ages to youth and is parallel with myopia progression. Currently, the only treatment for anisometropia is Ortho-K lenses as described for example in [5-8]. Ortho-K lenses are generally lenses configured to mechanically affect the curvature of the cornea. However, clinically there is a doubt if it is being used by Eye Care Professionals (ECP)s for treating anisometropia. There is currently no treatment or suggested solution for anisometropia which is based on the use of ophthalmic lenses, meaning spectacle lenses or contact lenses providing optical power for visual correction.

### GENERAL DESCRIPTION

Anisometropia refers hereinafter to any difference in Spherical Equivalent Refraction (SER). The present invention provides a myopia control lens being configured for controlling anisometropia in patients with at least one myopic or pre-myopic eye. More specifically, the invention relates to at least one ophthalmic lens for spectacles or contact lens configured for controlling and/or treating anisometropia (prevention and minimization). The ophthalmic lens of the present invention may be used in any anisometropic cases where at least one of the eyes is myopic or pre-myopic, whether the refraction and prescription is spherical and/or astigmatic. The term “controlling anisometropia” refers hereinafter both to the prevention of progression of difference between prescriptions of the two eyes of a patient and to the minimization of existing difference between prescriptions of the two eyes of a patient. The invention enables to affect the progression of myopia differently for each eye and, as a result, to bring both eyes to substantially the same level/degree of myopia or to minimize the difference between the two prescriptions. This enables thereafter (i.e. when both eyes have attained the substantially same level of myopia) to use, if needed, similar left and right myopia control lenses or treatment to slow down the myopia progression in both eyes with the same rate.

Therefore, according to a broad aspect of the present invention, there is provided a lens system for an individual with anisometropia having a different prescription (Rx) of each eye. The lens system includes at least one lens unit having an optical property profile defining (1) a central optical zone having an optical correction according to the Rx of a corresponding eye and (2) a peripheral zone being configured to provide at least one myopia controlling parameter, being determined to affect myopia progression differently for each eye corresponding to a desired amount of anisometropia. The amount of anisometropia refers to the difference between both eyes' SER. The desired amount of anisometropia may be set to a certain value corresponding to the complete reduction of the anisometropia, or to a difference of 0.25D, 0.5D, 0.75D or above. As described above, the at least one lens unit includes at least one ophthalmic lens. The peripheral zone is configured to provide at least one myopia controlling parameter being determined to control anisometropia and bring both eyes to substantially the same degree of myopia. The at least one myopia controlling parameter may include any parameter configured to affect and control the myopia progression, by way of, for example, affecting retinal peripheral defocus, peripheral blur, chromatic aberrations, creating visual cues and reducing retinal image contrast.

Each myopia controlling parameter may be characterized by its myopia controlling power that may vary between 0 (no myopia controlling power, e.g., a regular single vision lens) to 1 (maximum possible myopia controlling power), depending on the specific implementation of the selected myopia controlling parameter. The myopia controlling power of a myopia controlling parameter may be measured in Diopters, blur level, number, size and density of visual cues or any combination thereof, depending on the selected myopia controlling parameter.

In some embodiments, the lens unit providing at least one myopia controlling parameter affecting retinal peripheral defocus is an ophthalmic lens including myopic peripheral defocus parameter. The myopic peripheral defocus parameter enables to maximize myopic defocus and/or minimize hyperopic defocus of rays coming from far objects towards the eye. The lens of the present invention may impose at the periphery as much myopic defocus as possible, by placing rays coming from far in front of the retina. The term “myopic peripheral defocus parameter” refers to an optical feature generating an optical image being formed in front of the peripheral retina, for example by additional peripheral power.

The additional peripheral power may be determined as a function of at least one of: amount of anisometropia, Rx of each eye, axial length of each eye, age of the individual, rate of myopia progression or rate of myopic changes. The rate of myopia progression may be reflected by the amount of change in SER and/or the amount of change in axial length of either the less myopic eye or the more myopic eye in a certain time frame (for example, annual change of SER of the less myopic eye relative to the contralateral eye). The rate of myopic changes may be reflected by the rate in which the SER and/or the axial length of a pre-myopic eye (either hyperopic or emmetropic) progresses towards a more myopic state in a certain time frame. The time frame is not limited and can define any suitable time period such as days, months or years. In a specific and non-limiting example, a higher level of anisometropia is to be provided with a stronger additional peripheral power compared to a less severe case of anisometropia. Additionally or alternatively, a high prescription is to be provided with a myopia control lens configured with a stronger additional peripheral power compared to a lower prescription. Additionally or alternatively, a higher rate of myopia progression, or rate of myopic changes is to be provided with a myopia control lens configured with a stronger additional peripheral power compared to a lower rate of progression. Additionally or alternatively, a high axial length is to be provided with a stronger additional peripheral power than a shorter axial length. Additionally or alternatively, a child is to be provided with a stronger additional peripheral power than older patients. The maximum possible strength of the additional peripheral power that can be configured in each case depends upon the selected myopia controlling parameter and the level of compliance of the patient to that myopia controlling parameter.

Typically, anisometropia relates to three different anisometropic cases:
1. simple anisometropia: one eye is myopic, the other one is emmetropic;
2. compound anisometropia: both eyes are myopic or hyperopic.
3. mixed anisometropia: both eyes have refractive errors, but one is myopic and the other is hyperopic.

Accordingly, the technique of the presently disclosed subject matter may be implemented correspondingly as follows:
1. one of the lenses is configured as a myopia control lens for minimizing the myopia progression in the more myopic eye or in the less hyperopic eye as compared to the contralateral one. The other lens which may be a part of the lens system or not, may be a standard lens (e.g. having a single vision optical property profile, meaning having a single prescription aimed to correct the central (foveal) vision with no myopia controlling parameter) corresponding to a less myopic or more hyperopic eye, if needed; and/or
2. the lens system includes two lens units: one of the lenses is a myopia control lens configured with the strongest possible myopia controlling parameter (for example, the strongest possible additional peripheral power) to the more myopic eye and the other lens is configured as a myopia control lens with reduced myopia controlling parameter (for example, reduced additional peripheral power to the contralateral less myopic eye, compared to the additional peripheral power provided to the more myopic eye); and/or
3. when a hyperopic eye is pre-myopic and when there is a difference between refractions of both eyes, the lens of the more myopic or less hyperopic eye is configured to have an adjusted myopia controlling parameter (for example, adjustment of additional peripheral power) according to the amount of anisometropia (i.e. difference in right/left eye prescription and/or axial length), the monocular prescriptions and/or axial length of each eye. As described above, the age of the patient may also be considered.

These implementations minimize the difference between central refraction of both eyes, meaning minimizing the anisometropia. In other words, one of the lenses which is intended for use with that one of the left and right eyes in which the myopia is initially weaker or the hyperopia is higher, as compared to that of the other eye, is configured to affect the eye vision through the periphery of the lens allowing the natural or inhibited progress of myopia of that eye to bring it to the level of the other eye.

In some other embodiments, a pair of myopia control lenses for spectacles are provided, configured for differently affecting myopia development/progression based on the initial difference in the anisomyopic eyes of a patient (i.e. interocular difference of refractive power).

According to another broad aspect of the presently disclosed subject matter, there is provided a method for treating an individual with anisometropia. The method includes obtaining a prescription (Rx) for each eye; calculating an existing amount of anisometropia; determining a desired amount of anisometropia to be reached, wherein the desired amount of anisometropia is lower than the existing amount of anisometropia; configuring a central optical zone of at least one lens to have an optical correction according to the Rx of the corresponding eye and determining a myopia controlling parameter of a non-central position to affect a progression of a myopia differently for each eye corresponding to the desired amount of anisometropia; and configuring a peripheral zone with the myopia controlling parameter. In this connection, it should be noted that the method of the presently disclosed subject matter may be implemented by a preprogrammed processing unit or manually by any Eye Care Professional (ECP).

In some embodiments, determining the myopia controlling parameter of the non-central position includes determining at least one of a myopia controlling power of a myopic peripheral defocus parameter.

Determining the myopia controlling power of a myopic peripheral defocus parameter may include calculating the additional peripheral power as a function of at least one of: amount of anisometropia, Rx of each eye, axial length of each eye, age of the individual, rate of myopia progression or rate of myopic changes.

In some embodiments, the method further includes identifying the more myopic eye or less hyperopic eye as compared to the contralateral one.

In some embodiments, determining the myopia controlling parameter of the non-central position includes minimizing myopia progression of the more myopic eye or less hyperopic eye as compared to the contralateral one.

In some embodiments, the method further includes configuring at least one lens unit having the central optical zone and the determined myopia controlling parameter of a non-central position.

In some embodiments, the method further includes configuring at least one ophthalmic lens unit comprising at least one spectacle lens or at least one contact lens.

In some embodiments, the technique further includes configuring a second lens unit. The second lens unit may have a single vision optical property profile corresponding to a less myopic or more hyperopic eye as compared to the contralateral one.

In some embodiments, the technique further includes configuring a second lens unit having an optical property profile defining (1) a central optical zone having an optical correction according to the Rx of a corresponding eye and (2) a peripheral zone being configured to provide a myopia controlling parameter being configured to affect a progression of a myopia differently for each eye.

In some embodiments, determining the myopia controlling parameter of a first lens unit includes fitting a stronger additional peripheral power to a more myopic eye as compared to the contralateral one and configuring a second lens unit having a reduced additional peripheral power as compared to the contralateral one.

In some embodiments, the method further includes obtaining an age of an individual.

In some embodiments, the method further includes calculating the reduced additional peripheral power to the less myopic or more hyperopic eye compared to the additional peripheral power calculated for the more myopic or less hyperopic eye, according to at least one of an individual's age, axial length, Rx of the corresponding eye, rate of myopia progression or rate of myopic changes.

In some embodiments, the method further includes obtaining a second prescription (Rx) for each eye and after both eyes have a substantially same degree of myopia, configuring a central optical zone of each lens to have an optical correction according to the Rx of the corresponding eye and determining an optical property of a non-central position to affect and control the progression of a myopia similarly in both eyes.

According to another broad aspect of the presently disclosed subject matter, there is provided a processing unit for providing an individualized lens optical property profile. The processing unit includes a data input utility being configured and operable to receive a certain prescription (Rx) of an individual of each eye, a data analyzer being configured and operable to calculate an existing amount of anisometropia, determining a desired amount of anisometropia to be reached, wherein the desired amount of anisometropia is lower than the existing amount of anisometropia; configuring a central optical zone of at least one lens to have an optical correction according to the Rx of the corresponding eye and determining a myopia controlling parameter of a non-central position to affect a progression of the ametropia (according to prescriptions) differently for each eye corresponding to the desired amount of anisometropia; and configuring a peripheral zone with the myopia controlling parameter and a data output utility being configured and operable to provide a lens optical property profile defining a central optical zone having an optical correction according to the Rx of the corresponding eye and a peripheral zone with the myopia controlling parameter.

In some embodiments, the data analyzer is configured and operable to determine the myopia controlling parameter of the non-central position by determining at least one of a myopic peripheral defocus, peripheral blur, chromatic aberrations, creating visual cues or reducing retinal image contrast.

In some embodiments, the data analyzer is configured and operable to determine the myopia controlling power of the selected myopia controlling parameter.

In some embodiments the myopia controlling parameter is a myopic peripheral defocus parameter and determining the myopia controlling power includes determining the additional peripheral power.

In some embodiments, the data analyzer is configured and operable to determine the additional peripheral power by calculating the additional peripheral power as a function of at least one of: amount of anisometropia, Rx of each eye, axial length of each eye, age of the individual, rate of myopia progression or rate of myopic changes.

In some embodiments, the data analyzer is configured and operable to identify the more myopic eye or less hyperopic eye as compared to the contralateral one and to determine the myopia controlling parameter of the non-central position by minimizing myopia progression of the more myopic eye or less hyperopic eye as compared to the contralateral one.

In some embodiments, the data analyzer is configured and operable to configure at least one lens unit having the central optical zone and the determined myopia controlling parameter of a non-central position.

In some embodiments, the data analyzer is configured and operable to configure at least one lens unit comprising at least one spectacle lens or at least one contact lens.

In some embodiments, the data analyzer is configured and operable to configure a second lens unit.

In some embodiments, the data analyzer is configured and operable to configure a second lens unit having a single vision optical property profile corresponding to a less myopic or more hyperopic eye as compared to the contralateral one.

In some embodiments, the data analyzer is configured and operable to configure a second lens unit having an optical property profile defining (1) a central optical zone having an optical correction according to the Rx of a corresponding eye and (2) a peripheral zone being configured to provide a myopia controlling parameter being configured to affect a progression of a myopia differently for each eye.

In some embodiments, the data analyzer is configured and operable to determine the myopia controlling parameter of a first lens unit by fitting a stronger additional peripheral power to a more myopic eye as compared to the contralateral one and configuring the second lens unit to have a reduced additional peripheral power as compared to the contralateral one.

In some embodiments, the data input utility is configured and operable to receive an age of an individual.

In some embodiments, the data analyzer is configured and operable to determine the reduced additional peripheral power according to at least one of an amount of anisometropia, rate of myopia progression, rate of myopic changes, axial length of the corresponding eye, an individual's age and Rx of the corresponding eye.

In some embodiments, the data analyzer is adapted, after both eyes have a substantially same degree of myopia, to configure a central optical zone of each lens to have an optical correction according to the Rx of the corresponding eye and determine an optical property of a non-central position to affect and control the progression of myopia similarly in both eyes.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic diagram of a cross-section view a possible lens system of the presently disclosed subject matter;

FIG. 2 is a schematic block diagram of a processing unit according to one broad aspect of the presently disclosed subject matter; and

FIG. 3 is a schematic flow chart of a method of configuring a lens aimed at treating at least one eye of an individual with anisometropia according to another broad aspect of the presently disclosed subject matter.

### DETAILED DESCRIPTION OF EMBODIMENTS

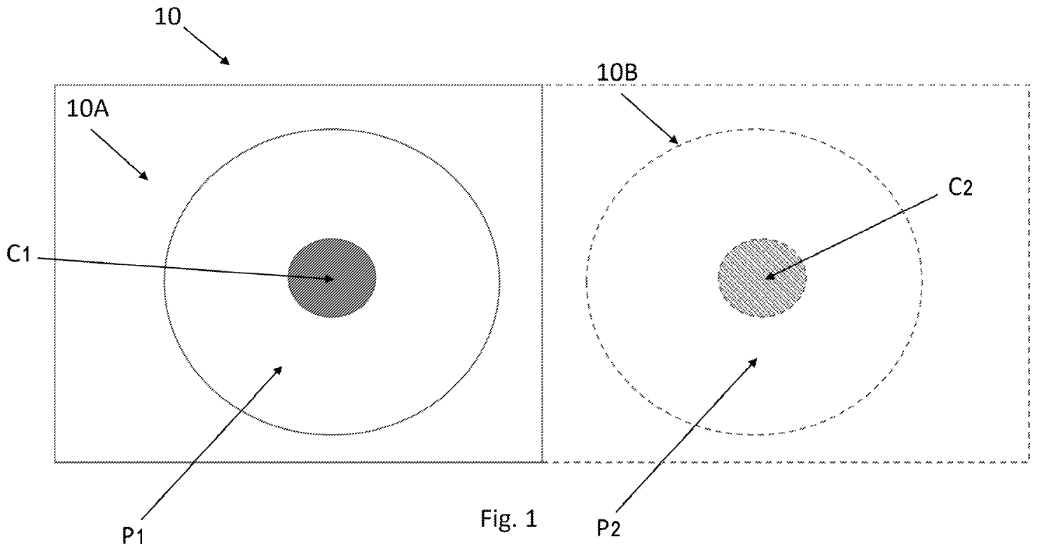

Reference is made to FIG. 1, showing a schematic illustration of a cross-section view of the lens system of the presently disclosed subject matter. Lens system 10 is configured for affecting and controlling the progression of myopia of an eye of an individual with anisometropia (i.e. having a different prescription (Rx) of each eye). Typically, prescription Rx includes optical parameters including at least one of sphere power, cylinder power and axis value, add power or prismatic power. Lens system 10 includes at least one lens unit 10A including an optical property profile defining (1) a central optical zone having an optical correction according to the Rx of a corresponding eye referred to in the figure as region C₁ and (2) a peripheral zone referred to in the figure as region P₁ being configured to provide at least one myopia controlling parameter, being determined to affect a progression of a myopia differently for each eye. It should be noted that the illustration is not limiting and that the figure does not represent the accurate size, shape or position of the different zones. The at least one myopia controlling parameter and its myopia controlling power is generally selected according to the desired decrease in the development rate of the myopia associated with the desired amount of anisometropia. In a specific and non-limiting example, the myopia controlling parameter is defined by the diopter power of the peripheral prescription. Therefore, the myopia controlling parameter may include any parameter of an ophthalmic lens which is configured to affect and control myopia progression by way of, for example, myopic peripheral defocus by additional peripheral power, creating peripheral blur, affecting chromatic aberrations, creating visual cues and reducing retinal image contrast. The myopia controlling parameter may be changed at stages of the treatment according to its progression. For example, in myopia control lenses that are designed based on additional peripheral power, the additional peripheral power P₁ of the lens can be configured to be at least 1D and may be changed at stages of the treatment according to its progression. The optical property profile of lens system 10 is customized to each individual and is based on the individual's prescription. The lens unit 10A may be an ophthalmic lens to be integrated into spectacles or a contact lens. As described above, the peripheral zone P₁ of lens unit 10A is configured to provide at least one myopia controlling parameter being configured to control anisometropia and bring both eyes to substantially the same degree of myopia. The at least one myopia controlling parameter comprising at least one of a myopic peripheral defocus parameter with additional peripheral power, optical feature creating peripheral blur, optical feature affecting chromatic aberrations, optical feature creating visual cues or optical feature for reducing a contrast of a retinal image. The myopia controlling power of each myopia controlling parameter may be determined as a function of at least one of amount of anisometropia, Rx of each eye, rate of myopia progression, or rate of myopic changes, axial length of each eye or age of the individual.

In some embodiments, lens system 10 further includes a second lens unit 10B. The second lens unit 10B may have a single vision optical property profile corresponding to a less myopic or more hyperopic eye as compared to the contralateral one. Alternatively, second lens unit 10B may have an optical property profile defining (1) a central optical zone having an optical correction according to the Rx of a corresponding eye referred to in the figure as region C₂ and (2) a peripheral zone being configured to provide a myopia controlling parameter being determined to affect a progression of a myopia differently for each eye referred to in the figure as region P₂.

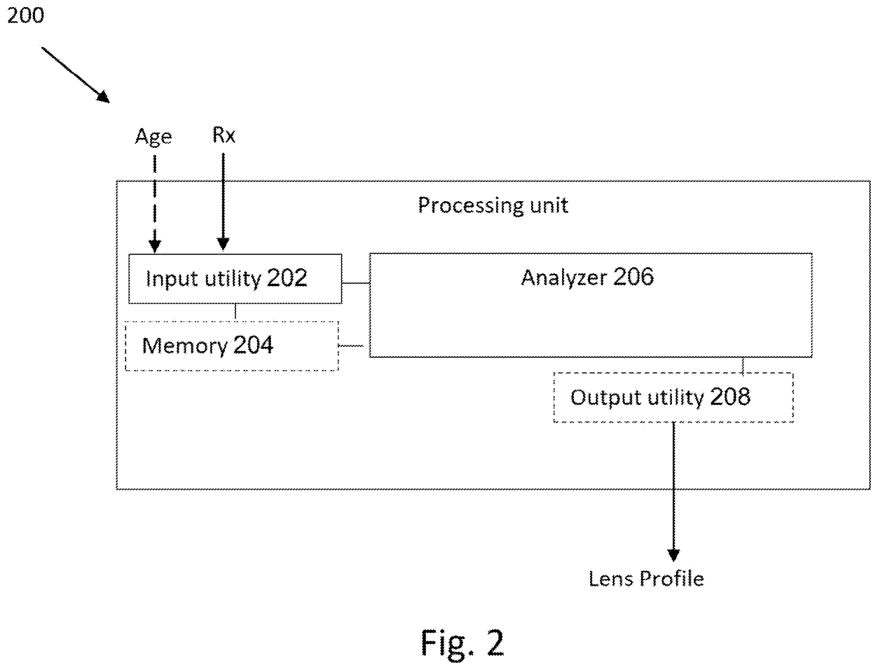

Reference is made to FIG. 2 showing a schematic block diagram of a processing unit for providing an individualized lens optical property profile according to one broad aspect of the presently disclosed subject matter. Processing unit 200 includes a computer system comprising a data analyzer 206 and being a part of and connected to a computer network. Processing unit 200 may include a general-purpose computer processor, which is programmed in software to carry out the functions described herein below. Unless specifically stated otherwise, as apparent from the following discussions, it is appreciated that throughout the specification discussions utilizing terms such as “determining”, “correlating”, “comparing”, “calculating”, “processing” or the like, refer to the action and/or processes of a computer that manipulate and/or transform data into other data. Also, operations in accordance with the teachings herein may be performed by a computer specially constructed for the desired purposes, or by a general-purpose computer specially configured for the desired purpose by a computer program stored in a computer readable storage medium. Processing unit 200 includes a data input utility 202 including a communication module for receiving a certain conventional prescription (Rx) of an individual for each eye and optionally the individual's age, an optional memory (i.e. non-volatile computer readable medium) 204 for storing the input/output data, a database or the computer program as will be detailed below, and a data analyzer 206 adapted to calculate an existing amount of anisometropia, determining a desired amount of anisometropia to be reached, configuring a central optical zone of at least one lens to have an optical correction according to the Rx of the corresponding eye, determining a myopia controlling parameter of a non-central position to affect a progression of a myopia differently for each eye corresponding to the desired amount of anisometropia; and configuring a peripheral zone with the myopia controlling parameter and a data output utility 208 being configured and operable to provide a lens optical property profile defining a central optical zone having an optical correction according to the Rx of the corresponding eye and a peripheral zone with the myopia controlling parameter. Memory 204 may be integrated within processing unit 200 or may be an external storage device accessible by processing unit 200. The software may be downloaded to analyzer 206 in electronic form, over a network, for example, or it may alternatively be provided on tangible media, such as optical, magnetic, or electronic memory media. Processing unit 200 includes at least one computer entity linked to a server via a network, wherein the network is configured to receive and respond to requests sent across the network, and also transmits one or more modules of computer executable program instructions and displayable data to the network connected user computer platform in response to a request, wherein the modules include modules configured to: receive and transmit optical property information, transmitting a lens profile recommendation based on the calculated correlation, for display by the network connected user computer platform. The disclosed subject matter may include computer program instructions stored in the local storage that, when executed by processing unit 200, cause processing unit 200 to receive prescription data and/or age data of an individual and determine at least one optical property of a lens. The computer program product may be stored on a tangible computer readable medium, comprising: a library of software modules which cause a computer executing them to prompt for information pertinent to an optical lens profile recommendation, and to store the information or to display optical lens profile recommendations. The computer program may be intended to be stored in memory 204 of processing unit 200, or in a removable memory medium adapted to cooperate with a reader of the processor unit 200, comprising instructions for implementing the method as will be described below. More specifically, the computer program may be in communication with an interface to receive the prescription data.

In some embodiments, data analyzer 206 is configured and operable to configure at least one lens unit having the central optical zone and the determined myopia controlling parameter of a non-central position. This may be implemented by determining the myopia controlling parameter of the non-central position and defining the myopia controlling power of the determined myopia controlling parameter. For example, data analyzer 206 is configured and operable to determine the myopia controlling parameter of the non-central position by minimizing myopia progression of the more myopic eye or less hyperopic eye as compared to the contralateral one. Alternatively, data analyzer 206 is configured and operable to determine the myopia controlling parameter of a first lens unit by fitting a stronger additional peripheral power to a more myopic eye as compared to the contralateral one and configuring the second lens unit to have a reduced additional peripheral power as compared to the contralateral one. Alternatively, data analyzer 206 is configured and operable to determine the reduced additional peripheral power according to at least one of an amount of anisometropia, rate of myopia progression, rate of myopic changes, axial length of the corresponding eye, an individual's age and Rx of the corresponding eye. In a specific and non-limiting example, in case of a relatively high rate of myopia progression of the less myopic eye, the additional peripheral power may be reduced but to a lesser extent than in a case of a moderate rate of myopia progression. After both eyes have a substantially same degree of myopia data analyzer 206 is adapted to configure a central optical zone of each lens to have an optical correction according to the Rx of the corresponding eye and determine an optical property of a non-central position to affect and control the progression of myopia similarly in both eyes.

The following Table 1 represents examples of a normalized power of myopia controlling parameter prescribed for the more myopic eye for different age groups:

TABLE 1

| | Anisometropia | | |
|---|---|---|---|
| Age | 0.25 D-0.75 D | 1.00 D-1.50 D | 1.75 D or more |
| 7 or younger | 0.6-0.7 | 0.75-1 | 1 |
| 7-10 | 0.5-0.6 | 0.75-0.85 | 1 |
| 10 or older | 0.4-0.5 | 0.6-0.7 | 1 |

In this connection, it should be understood that the values of the normalized power of myopia controlling parameter varies between 0 and 1, when 0 represents no myopia controlling power, e.g., a regular single vision lens and 1 represents the maximum possible myopia controlling power of the selected myopia controlling parameter. Moreover, the values above are empiric approximative values, representing values in the range of plus or minus 10 percent and should not be considered as absolute precise values. The maximum possible myopia controlling power of the lens is determined according to the specification of the selected myopia controlling parameter and compliance of the patient. The normalization of the values within the range may be linear, logarithmic, exponential, polynomial or power, depending on the nature of the selected myopia controlling parameter. The selection of the appropriate value is determined according to a plurality of parameters including the age of the patient, his initial prescription or the expected decrease in the development rate of the myopia. On one side, high values of the myopia controlling parameter induce some distortions or aberrations, increasing the blur perception and reducing the capacity of the patient to view therethrough. On the other side, low values of the myopia controlling parameter may not suffice to affect myopia progression. Therefore, the selection of the values of the myopia controlling parameter enables to control the personalized myopic progression of each specific patient including the desired amount of anisometropia and the development rate of the myopia to be reached. The different proposed theoretical values in this and the examples described below are not limiting the configuration of the lens for which a plurality of other parameters should be taken into consideration such as parameters typically related to the technique of production of the lens.

The following Table 2 represents examples of a normalized power of myopia controlling parameter prescribed for the two eyes for different age groups:

TABLE 2

| | Anisometropia | | | | | |
|---|---|---|---|---|---|---|
| | 0.25 D-0.75 D | | 1.00 D-1.50 D | | 1.75 D or more | |
| | More | Less | More | Less | More | Less |
| Age | myopic | myopic | myopic | myopic | myopic | myopic |
| 7 or younger | 0.6-0.7 | 0.45-0.55 | 0.75-1 | 0.4-0.5 | 1 | 0.2-0.3 |
| 7-10 | 0.5-0.6 | 0.35-0.45 | 0.75-0.85 | 0.3-0.4 | 1 | 0.2-0.3 |
| 10 or older | 0.4-0.5 | 0.3-0.4 | 0.6-0.7 | 0.3-0.4 | 1 | 0.2-0.3 |

As described above, Table 2 illustrates one embodiment of the presently disclosed subject matter in which the myopia controlling power of the myopia controlling parameter of the contralateral less myopic eye is reduced as compared to the myopia controlling power provided to the more myopic eye.

As described above, in some embodiments, the additional peripheral power may be determined as a function of rate of myopia progression, or rate of myopic changes of the less myopic eye or the more myopic eye relative to the contralateral eye. The following Table 3 illustrates one embodiment of the presently disclosed subject matter in which the myopia controlling power of the myopia controlling parameter of the contralateral less myopic eye is reduced as compared to the myopia controlling power provided to the more myopic eye. In particular Table 3 represents examples of a normalized power of myopia controlling parameter prescribed for the two eyes for different annual progression rate of the less myopic eye. As illustrated in the table for a higher rate of myopia progression, the myopia control lens is configured with a stronger additional peripheral power compared to a lower rate of progression.

TABLE 3

| Annual | Anisometropia | | | | | |
|---|---|---|---|---|---|---|
| progression | 0.25 D-0.75 D | | 1.00 D-1.50 D | | 1.75 D or more | |
| rate of less | More | Less | More | Less | More | Less |
| myopic eye | myopic | myopic | myopic | myopic | myopic | myopic |
| >1 D | 0.6-0.7 | 0.45-0.55 | 0.75-1 | 0.4-0.5 | 1 | 0.2-0.3 |
| >0.5 D ≤ 1 D | 0.5-0.6 | 0.35-0.45 | 0.75-0.85 | 0.3-0.4 | 1 | 0.15-0.25 |
| ≤0.5 D | 0.4-0.5 | 0.25-0.4 | 0.6-0.7 | 0.25-0.35 | 1 | 0 |

The following Table 4 represents examples of additional peripheral power of myopic peripheral defocus parameter prescribed for the more myopic eye for different age groups:

TABLE 4

| | Anisometropia | | |
|---|---|---|---|
| Age | 0.25 D-0.75 D | 1.00 D-1.50 D | 1.75 D or more |
| 7 or younger | 2 D | 2.5 D-3.00 D | 3 D-4 D |
| 7-10 | 1.5 D | 2.5 D | 3 D-4 D |
| 10 or older | 1 D | 2 D | 3 D-4 D |

In this example of Table 4, the maximal power compliance is determined to be +4D. For example, at younger ages, the additional peripheral power should be stronger compared to the additional peripheral power given in older ages.

In this specific and non-limiting example, the less myopic (i.e. contralateral eye) can have a single vision lens with its prescription, until the anisometropia is reduced completely, or to 0.25D, 0.5D, 0.75D or 1.00D (the difference between both eyes prescriptions). Myopia control lenses may be then fitted to both eyes.

The following are few non-limiting examples of the lens configuration, i.e. the optical power distribution map of the lenses, as well as a relation between the eye vision (prescription) and the lens map, and examples of different maps for different eyes based on the values defined in Tables 1-3 above.

A six-year-old individual has a prescription in which the right eye has a refractive error of −0.25D and the left eye has a refractive error of −1.50D. Processing unit 200 calculates that the amount of anisometropia is 1.25D and determines that the desired amount of anisometropia should be minimized as much as possible. Processing unit 200 identifies that the less myopic eye is the right eye and configures the lens of the right eye to be a “standard lens” i.e. to have a single vision lens having a dioptric power of −0.25D and the lens of the left eye to have a central region having a dioptric power of −1.50D and a peripheral region with a myopic peripheral defocus parameter having an additional peripheral power of +3D. When the difference between the eyes is reduced, the lenses of both eyes may be configured as myopia control lenses with a peripheral region having an additional peripheral power of +3D.

For the same subject, with the same prescriptions, the lens of the right eye may be configured to be a “standard lens” i.e. to have a single vision lens having a dioptric power of −0.25D and the lens of the left eye is configured to have a central region having a dioptric power of −1.50D and a myopia controlling parameter of reducing retinal image contrast with peripheral contrast reduction of 50% relative to an image contrast viewed using the clear aperture of the lens. When the difference between the eyes is reduced, the lenses of both eyes may be configured as myopia control lenses with a peripheral contrast reduction of 50% relative to an image contrast viewed using the clear aperture of the lens for best controlling both eyes myopia.

In another specific and non-limiting example, in which the right eye has a refractive error of −5.00D and the left eye has a refractive error of −7.50D, processing unit 200 identifies that the less myopic eye is the right eye and configures the lens of the right eye to be a “standard lens” i.e. to have a single vision lens having a dioptric power of

−5.00D and the lens of the left eye may be configured to have a central region having a dioptric power of −7.50D and a peripheral region with a myopic peripheral defocus parameter having an additional peripheral power of +3D. It should be noted that in this example, the age is not taken into consideration since the amount of anisometropia as well as the value of the myopia is high. The additional peripheral power is determined to be the maximal value (e.g. +3D). This example may be given for any age. When the difference between the eyes is reduced, the lenses of both eyes may be configured as myopia control lenses with a peripheral region having an addition power of +3D.

For the same subject, with the same prescriptions, the lens of the right eye is configured to be a “standard lens” i.e. to have a single vision lens having a dioptric power of −5.00D and the lens of the left eye is configured to have a central region having a dioptric power of −7.50D and a myopia controlling parameter of reducing retinal image contrast with peripheral contrast reduction of 60% relative to an image contrast viewed using the clear aperture of the lens, due to the high prescriptions and anisometropia. When the difference between the eyes is reduced, the lenses of both eyes may be configured as myopia control lenses with a peripheral contrast reduction of 50% relative to an image contrast viewed using the clear aperture of the lens for best controlling both eyes myopia.

As described above, the second implementation of the technique of the presently disclosed subject matter is configuring one lens by fitting the strongest, or strong enough additional peripheral power to the more myopic eye and configuring the other lens by providing a myopia control lens with reduced additional peripheral power to the contralateral less myopic eye. This lower peripheral power may be adjusted according to the age and prescription of the less myopic eye of the patient and may be changed and adjusted at some stages of treatment, according to the myopia progression of each eye, rate of myopia progression or rate of myopic changes. When anisometropia is reduced completely, or to 0.25D, 0.5D, 0.75D or 1.00D (the difference between both eyes prescriptions), myopia control lenses with the same peripheral power or single vision lenses are then fitted to both eyes.

In one specific and non-limiting example, in which the right eye of a seven years old individual has a refractive error of −0.25D and the left eye has a refractive error of −1.50D, the lens of the right eye is configured to have a central region having a dioptric power of −0.25D and a peripheral region having an addition power of +1.5D for controlling its myopia, but in a weaker power compared to the more myopic eye and the lens of the left eye is configured to have a central region having a dioptric power of −1.50D and a peripheral region having an addition power of +2.5D. The additional power is given to prevent from the more myopic eye, higher progression of the myopia. When the difference between the eyes is reduced, the lenses of both eyes may be configured as myopia control lenses with a peripheral region having an addition power of +3D for best controlling both eyes myopia.

In a specific and non-limiting example, for the same subject, with the same prescription, if the rate of annual progression of myopia in the right eye is 1.00D, the lens of the right eye may be configured to have a central region having a dioptric power of −0.25D and a peripheral region having an addition power of +1.50D for controlling its myopia, and the lens of the left eye may be configured to have a central region having a dioptric power of −1.50D and a peripheral region having an addition power of +2.50D.

However, if the rate of annual progression of myopia in the right eye is 0.50D, the lens of the right eye may be configured to have a central region having a dioptric power of −0.25D and a peripheral region having an addition power of +1.00D for controlling its myopia, and the lens of the left eye may be configured to have a central region having a dioptric power of −1.50D and a peripheral region having an addition power of +2.25D. When the difference between the eyes is reduced, the lenses of both eyes may then be configured as myopia control lenses with a peripheral region having an addition power of +3D for optimizing the control of both eyes' myopia.

In another specific and non-limiting example, for the same subject, with the same prescription, the lens of the right eye may be configured to have a central region having a dioptric power of −0.25D and a myopia controlling parameter of reducing retinal image contrast with peripheral contrast reduction of 40% relative to an image contrast viewed using the clear aperture of the lens. The lens of the left eye may be configured to have a central region having a dioptric power of −1.50D and a myopia controlling parameter of reducing retinal image contrast with peripheral contrast reduction of 50% relative to an image contrast viewed using the clear aperture of the lens. When the difference between the eyes is reduced, the lenses of both eyes may be then configured as myopia control lenses with a peripheral contrast reduction of 50% relative to an image contrast viewed using the clear aperture of the lens for optimizing the control of both eyes' myopia.

In another specific and non-limiting example, in which the right eye has a refractive error of −4.5D and the left eye has a refractive error of −7.00D, the lens of the right eye is configured to have a central region having a dioptric power of −4.5D and a peripheral region having an addition power of +2D and the lens of the left eye is configured to have a central region having a dioptric power of −7.00D and a peripheral region having an addition power of +3D Also, in this example, the age is not taken into consideration since the amount of anisometropia as well as the value of the myopia is high. The additional peripheral power is determined to be the maximal value (e.g. +3D). This example may be given for any age.

When the difference between the eyes is reduced, but anisometropia still exists, to correctly treat the myopia in both eyes, the difference between the addition powers between the eyes may be reduced and therefore, the right eye can have a myopia control lens with additional peripheral power of +2.5D and the left eye can have myopia control lens with additional peripheral power of +3D.

When anisometropia is reduced completely, or to 0.25D, 0.5D, 0.75D or 1.00D (the difference between both eyes prescriptions), myopia control lenses can be configured with additional peripheral power of +3D to both eyes.

As described above, a third implementation of the technique of the presently disclosed subject matter is using this treatment for preventing the development of anisometropia by using it in early stages, when the child is still not a myope, but the peripheral refraction of the retina becomes hyperopic. Researchers found that children who became myopic have hyperopic peripheral refractive errors 1-2 years before the onset of myopia [9], and that the onset of myopia is well predicted by a refractive error <+0.75 D at 6 years, <+0.50 D at 7 to 8 years, <+0.25 D at 9 to 10 years, and less than plano at 11 years [10, 11]. At these cases, when there is a difference between refractions of both eyes, and at least one of them seems to become myopic or pre-myopic, the more myopic or less hyperopic eye may be configured to have a myopia control lens and the contralateral eye may have plano SV lens. Its prescription may be adjusted according to the development of prescriptions of both eyes. The myopia controlling parameter of the lens may be fitted according to the age of the child, the amount of anisometropia (difference in right/left eye prescription and/or axial length), the monocular prescriptions, axial length of each eye and/or the rate of myopic changes. The treatment is suitable for anisometropic children where the refractive error differs between the two eyes in 0.25D, 0.5D, 0.75D, 1.00D, 1.25D, 1.50D or more.

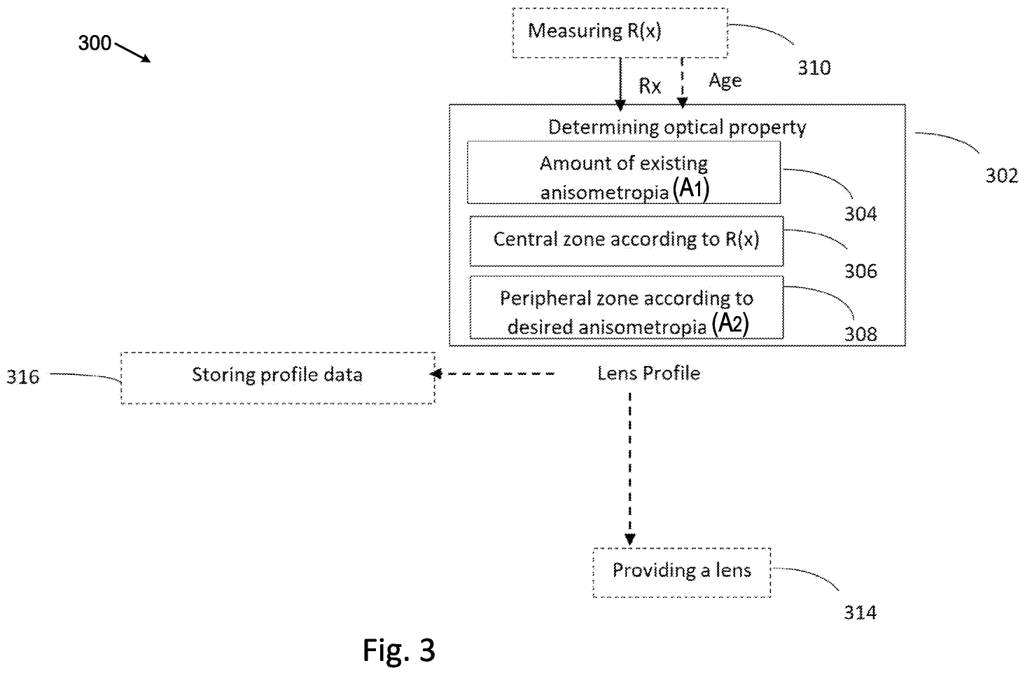

According to a broad aspect of the presently disclosed subject matter, there is provided a method of configuring a lens aimed at treating an anisometropic individual having a certain prescription (Rx). Reference is made to FIG. 3, exemplifying, by the way of a flow chart, the main steps of method 300 of the presently disclosed subject matter. Method 300 includes obtaining a prescription (Rx) for each eye and optionally obtaining an age of the individual, determining an optical property of a lens in 302 by calculating an existing amount of anisometropia A₁ in 304, configuring a central optical zone of at least one lens to have an optical correction according to the Rx of the corresponding eye in 306 and determining a myopia controlling parameter of a non-central position to affect a progression of a myopia differently for each eye in 308 corresponding to the desired amount of anisometropia A₂.

In some embodiments, method 300 further includes configuring at least one lens unit having the central optical zone and the determined myopia controlling parameter of a non-central position in 314.

In some embodiments, method 300 includes the initial step of measuring a prescription (Rx) of at least one eye in 310. Optionally, method 300 may include storing all the data into a database in 316.

1. A lens system for an individual with anisometropia, the lens system comprising at least one lens unit having an optical property profile defining (1) a central optical zone having an optical correction according to the Rx of a corresponding eye and (2) a peripheral zone being configured to provide at least one myopia controlling parameter, being determined to affect a myopia progression differently for each eye corresponding to a desired amount of anisometropia.

2. The lens system of claim 1, wherein the at least one lens unit comprises at least one spectacle lens or at least one contact lens.

3. The lens system of claim 1 or claim 2, wherein the peripheral zone is configured to provide at least one myopia controlling parameter being determined to control anisometropia and bring both eyes to substantially the same degree of myopia.

4. The lens system of claim 3, wherein the at least one myopia controlling parameter comprises at least one of a myopic peripheral defocus parameter with additional peripheral power, optical feature creating peripheral blur, optical feature affecting chromatic aberrations, optical feature creating visual cues or optical feature reducing retinal image contrast.

5. The lens system of claim 4, wherein each myopia controlling parameter comprises a myopia controlling power being determined as a function of at least one of an amount of anisometropia, Rx of each eye, rate of myopia progression, rate of myopic changes, axial length of each eye or age of the individual.

6. The lens system of any one of the preceding claims, wherein the myopia controlling parameter is configured to minimize myopic progression of the more myopic eye or less hyperopic eye as compared to the contralateral one.

7. The lens system of any one of the preceding claims, further comprising a second lens unit.

8. The lens system of claim 7, wherein the second lens unit has a single vision optical property profile.

9. The lens system of claim 8, wherein the second lens unit has a single vision optical property profile corresponding to a less myopic or more hyperopic eye as compared to the contralateral one.

10. The lens system of claim 7, wherein the second lens unit has an optical property profile defining (1) a central optical zone having an optical correction according to the Rx of a corresponding eye and (2) a peripheral zone being configured to provide a myopia controlling parameter being determined to affect a progression of a myopia differently for each eye.

11. The lens system of claim 10, wherein the myopia controlling parameter of a first lens unit is configured to fit a stronger additional peripheral power to a more myopic eye as compared to the contralateral one and the myopia controlling parameter of the second lens unit is configured to have a reduced additional peripheral power as compared to the contralateral one.

12. The lens system of claim 11, wherein the additional peripheral power is determined according to at least one of an amount of anisometropia, rate of myopia progression, rate of myopic changes, axial length of the corresponding eye, an individual's age or Rx of the corresponding eye.

13. A method for treating an individual with anisometropia, the method comprising:
obtaining a prescription (Rx) for each eye;
calculating an existing amount of anisometropia;
determining a desired amount of anisometropia to be reached, wherein the desired amount of anisometropia is lower than the existing amount of anisometropia;
configuring a central optical zone of at least one lens to have an optical correction according to the Rx of the corresponding eye; and
determining a myopia controlling parameter of a non-central position to affect a progression of a myopia differently for each eye corresponding to the desired amount of anisometropia; and
configuring a peripheral zone with the myopia controlling parameter.

14. The method of claim 13, wherein determining the myopia controlling parameter of the non-central position comprises determining at least one of a myopic peripheral defocus, peripheral blur, chromatic aberrations, creating visual cues or reducing retinal image contrast.

15. The method of claim 13 or claim 14, wherein determining a myopia controlling parameter comprises determining a myopic peripheral defocus parameter.

16. The method of any one of claim 13 to claim 15, wherein determining a myopia controlling parameter comprises determining a myopia controlling power of a myopia controlling parameter.

17. The method of claim 16, wherein determining the myopia controlling power comprises determining an additional peripheral power.

18. The method of claim 17, wherein determining the additional peripheral power comprises calculating the additional peripheral power as a function of at least one of an amount of anisometropia, Rx of each eye, rate of myopia progression, rate of myopic changes, axial length of each eye or age of the individual.

19. The method of any one of claim 13 to claim 18, further comprising identifying the more myopic eye or less hyperopic eye as compared to the contralateral one.

20. The method of claim 19, wherein determining the myopia controlling parameter of the non-central position comprises minimizing myopic progression of the more myopic eye or less hyperopic eye as compared to the contralateral one.

21. The method of any one of claim 13 to claim 20, further comprises configuring at least one lens unit having the central optical zone and the determined myopia controlling parameter of a non-central position.

22. The method of claim 21, further comprises configuring at least one lens unit comprising at least one spectacle lens or at least one contact lens.

23. The method of claim 22, further comprises configuring a second lens unit.

24. The method of claim 23, further comprises configuring a second lens unit having a single vision optical property profile corresponding to a less myopic or more hyperopic eye as compared to the contralateral one.

25. The method of claim 23, further comprises configuring a second lens unit having an optical property profile defining (1) a central optical zone having an optical correction according to the Rx of a corresponding eye and (2) a peripheral zone being configured to provide a myopia controlling parameter being configured to affect a progression of a myopia differently for each eye.

26. The method of any one of claim 25, wherein determining the myopia controlling parameter of a first lens unit comprises fitting a stronger additional peripheral power to a more myopic eye as compared to the contralateral one and configuring the second lens unit to have a reduced additional peripheral power as compared to the contralateral one.

27. The method of claim 26, further comprises obtaining an age of an individual.

28. The method of claim 27, further comprises calculating the reduced additional peripheral power to the less myopic or more hyperopic eye compared to the additional peripheral power calculated for the more myopic or less hyperopic eye, according to at least one of an individual's age, rate of myopia progression, rate of myopic changes, axial length and Rx of the corresponding eye.

29. The method of any one of claim 13 to claim 28, further comprises, obtaining a second prescription (Rx) for each eye and after both eyes have a substantially same degree of myopia, configuring a central optical zone of each lens to have an optical correction according to the Rx of the corresponding eye and determining an optical property of a non-central position to affect and control the progression of a myopia similarly in both eyes.

30. A processing unit for providing an individualized lens optical property profile, the processing unit comprising a data input utility being configured and operable to receive a certain prescription (Rx) of an individual of each eye, a data analyzer being configured and operable to calculate an existing amount of anisometropia, determining a desired amount of anisometropia to be reached, wherein the desired amount of anisometropia is lower than the existing amount of anisometropia; configuring a central optical zone of at least one lens to have an optical correction according to the Rx of the corresponding eye and determining a myopia controlling parameter of a non-central position to affect a progression of a myopia differently for each eye corresponding to the desired amount of anisometropia; and configuring a peripheral zone with the myopia controlling parameter and a data output utility being configured and operable to provide a lens optical property profile defining a central optical zone having an optical correction according to the Rx of the corresponding eye and a peripheral zone with the myopia controlling parameter.

31. The processing unit of claim 30, wherein the data analyzer is configured and operable to determine the myopia controlling parameter of the non-central position by determining at least one of a myopic peripheral defocus, peripheral blur, chromatic aberrations, creating visual cues or reducing retinal image contrast.

32. The processing unit of claim 30 or claim 31, wherein the myopia controlling parameter comprises a myopic peripheral defocus parameter.

33. The processing unit of any one of claim 30 to claim 32, wherein the data analyzer is configured and operable to determine the myopia controlling power of a selected myopia controlling parameter.

34. The processing unit of claim 33, wherein the myopia controlling power comprises an additional peripheral power.

35. The processing unit of claim 34, wherein the data analyzer is configured and operable to determine the additional peripheral power by calculating the additional peripheral power as a function of at least one of amount of anisometropia, Rx of each eye, rate of myopia progression, rate of myopic changes, axial length of each eye or age of the individual.

36. The processing unit of any one of claims 30 to 35, wherein the data analyzer is configured and operable to identify the more myopic eye or less hyperopic eye as compared to the contralateral one.

37. The processing unit of claim 36, wherein the data analyzer is configured and operable to determine the myopia controlling parameter of the non-central position by minimizing myopic progression of the more myopic eye or less hyperopic eye as compared to the contralateral one.

38. The processing unit of any one of claims 30 to 37, wherein the data analyzer is configured and operable to configure at least one lens unit having the central optical zone and the determined myopia controlling parameter of a non-central position.

39. The processing unit of claim 38, wherein the data analyzer is configured and operable to configure at least one lens unit comprising at least one spectacle lens or at least one contact lens.

40. The processing unit of claim 39, wherein the data analyzer is configured and operable to configure a second lens unit.

41. The processing unit of claim 40, wherein the data analyzer is configured and operable to configure a second lens unit having a single vision optical property profile corresponding to a less myopic or more hyperopic eye as compared to the contralateral one.

42. The processing unit of claim 40, wherein the data analyzer is configured and operable to configure a second lens unit having an optical property profile defining (1) a central optical zone having an optical correction according to the Rx of a corresponding eye and (2) a peripheral zone being configured to provide a myopia controlling parameter being configured to affect a progression of a myopia differently for each eye.

43. The processing unit of claim 42, wherein the data analyzer is configured and operable to determine the myopia controlling parameter of a first lens unit by fitting a stronger additional peripheral power to a more myopic eye as compared to the contralateral one and configuring the second lens unit to have a reduced additional peripheral power as compared to the contralateral one.

44. The processing unit of claim 43, wherein the data input utility is configured and operable to receive an age of an individual.

45. The processing unit of claim 44, wherein the data analyzer is configured and operable to determine the reduced additional peripheral power according to at least one of an amount of anisometropia, rate of myopia progression, rate of myopic changes, axial length of the corresponding eye, an individual's age or Rx of the corresponding eye.

46. The processing unit of any one of claim 30 to claim 45, wherein the data analyzer is adapted, after both eyes have a substantially same degree of myopia, to configure a central optical zone of each lens to have an optical correction according to the Rx of the corresponding eye and determine an optical property of a non-central position to affect and control the progression of a myopia similarly in both eyes.
